(19) United States
(12) Patent Application Publication
(10) Pub. No.: US 2005/0236805 A1
(43) Pub. Date: Oct. 27, 2005

(54) Powered stand device for motorcycle

(76) Inventor: Ching-Tung Chen, Taipei (TW)

Correspondence Address: Johnson & Associates P.C., 14625 Baltimore Avenue #282, Laurel, MD, 20707, US

(21) Appl. No.: 11/082,959

(22) Filed: Mar. 18, 2005

(30) Foreign Application Priority Data
Mar. 19, 2004 (TW) 93204195

(51) Int. Cl. B62H 1/00

(52) U.S. Cl. 280/293

(57) ABSTRACT

This invention relates to a kind of powered stand device for motorcycle. It can be worked by the twin middle prop that is under the motorcycle through the driving motor, transmission gear wheel system operated with transmission linkage. Thus the rider doesn't need to get off the motorcycle, just needs to press the button and the twin middle prop which is below the motorcycle will be been onward, turned around and dropped from the original back place. The motorcycle itself will be propped up automatically by leverage. The activity of parking is completed by motor method to exempt from the inconvenience that riders need to move the motorcycles laboriously.

### BACKGROUND OF THE INVENTION

1. Field of the Invention

The present invention relates to a powered stand device for motorcycle. That riders just needs to press the button to make the twin middle prop which is under the motorcycle move onward then drop down to prop the body of motorcycle and complete the parking activity, moreover, it could be rotated rearward and lifted up then riders can start to ride. It's a kind of motor device that it could complete propping the body of motorcycle and rising or descending activity automatically. Don't need to move the motorcycles laboriously, the advantages included simplify structure and convenient.

2. Description of Related Prior Art

Motorcycle is a convenient and economical vehicle, but its weight and stable level sometimes is a huge load for the riders whose body is smaller and weaker. To use the traditional middle prop could reduce the total weight of motorcycle through leverage, it could be moved to backseat namely support the whole one. The method actually is not perfect. In the process, the rider needs to press down the prop by one foot to be the strong point of lever, and hold the handles then pull the motorcycle rearward laboriously to lift it up and make the middle prop to be the strong point. It is strenuous when female and people who have smaller figure and strength, especially heavy motorcycle. It will be more difficult to operate.

In addition, it's difficult to search a parking space due to the traffic jam in most of city and too many motorcycles in the modem city so that riders need to park their motorcycles under narrow space. At this time, riders (or their motorcycles) often hit other motorcycles easily when they are parking and it may not have enough space that riders stand beside their own motorcycles when lifting it up.

### SUMMARY OF THE INVENTION

The invention is special for solving the inconvenience that riders park the traditional motorcycles. Riders don't need to get it off, just press the button to make the twin middle prop which is under the motorcycle move 80 degree onward to the middle part of motorcycle then prop it up by motor method and parking is completed. Not only riders don't need to get off their motorcycles to complete the parking activity but also don't feel inconvenient when they park under narrow space. Female and people who has smaller figure and strength will complete the parking easily. Riders don't need to worry the weight of heavy motorcycle when they ride it. As long as using this invention, everyone can park any kind of motorcycle even if female or people who has smaller figure and strength.

The rider just needs to press the button to make the middle prop that support the motorcycle to rotate rearward then drop the body down. The middle prop will go back the original place under the back area of the motorcycle. Then the rider can start to ride.

It is not only completely solved the inconvenience of parking traditional motorcycle but also make the process of parking be automatic. Regard to riders, the operation is very simple and convenient to complete the process easily and operate it by press the button only.

### BRIEF DESCRIPTION OF THE DRAWINGS

FIG. 1 is the front view of the invention.

FIG. 2 is the lateral view of this invention.

### REFERENCE NUMBERS IN DRAWINGS

1. electric button typed switch
2. driving motor
3. transmission-spur gear
4. transmission-bevel gear
5 eccentric transmission gear
6 eccentric transmission linkage
7 sliding shaft with piston route
8 fixed base for sliding shaft
9 middle-curved prop with transmission linkage
10 middle-prop fixed shaft
11 twin-middle prop

### DETAILED DESCRIPTION OF THE INVENTION

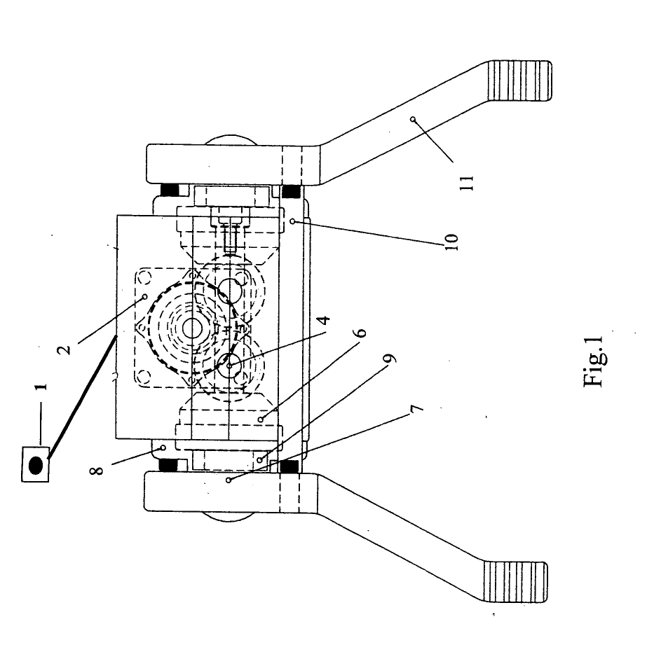

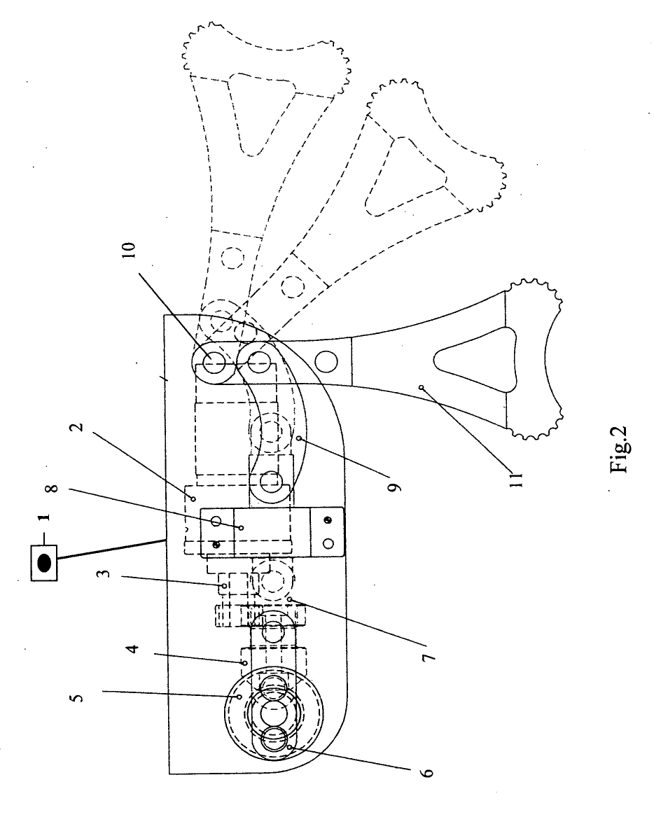

Referring to FIG. 1 and FIG. 2, the Powered Stand Device for Motorcycle is installed under the motorcycle. If riders would like to use this device to park, they just need to press the electric button typed switch (1) that installed on the motorcycle to make the driving motor (2) start, transmit the motive power to transmission-spur gear (3), then transmit to transmission-bevel gear (4) that linked with transmission-spur gear. The motive power from transmission-bevel gear (4) transmit to eccentric transmission gear (5) and promote eccentric transmission linkage (6) to make the sliding shaft with piston route (7) which linked with eccentric transmission linkage (6) start to move front and rear. There is a fixed base for sliding shaft (8) which functions as fixed the sliding shaft with piston route (7), finally, the sliding shaft with piston route (7) promote middle-curved prop with transmission linkage (9), which is linked with the sliding shaft with piston route (7) to make the twin-middle prop (11), that is fixed by middle-prop fixed shaft (10) rotating 80 degree onward from the original back place until the body of motorcycle lifted up and be vertical with it by leverage, then complete the parking after propped up the later half part of motorcycle.

If riders would like to ride the motorcycle which parked, they just need to press the electric button typed switch (1) that installed on the motorcycle to make the driving motor (2) start, transmit the motive power to transmission-spur gear (3), then transmit to transmission-bevel gear (4) that connect with transmission-spur gear (3). The motive power from transmission-bevel gear (4) transmit to eccentric transmission gear (5) and promote eccentric transmission linkage (6) to make the sliding shaft with piston route (7) which connect with eccentric transmission linkage (6) start to move front and rear. There is a fixed base for sliding shaft (8) which functions as fixed the sliding shaft with piston route (7), finally, the sliding shaft with piston route (7) promote middle-curved prop transmission linkage (9), which is linked with the sliding shaft with piston route (7) to make the twin-middle prop (11), that is fixed by middle-prop fixed shaft (10) rotating 80 degree backward from the vertical status until it went back the original back place. Thus riders could start to ride their motorcycles.

From above-mentioned method, this invention makes the process of parking and start to ride be functional as automatic. Riders can complete the process easily by press the button only.

1. A powered stand device for motorcycle comprising:
(a) A driving motor can be started the motive power to transmission-spur gear;
(b) A transmission-spur gear can be transmitted the motive power to transmission-bevel gear;
(c) A transmission-bevel gear can be promoted the eccentric transmission gear;
(d) An eccentric transmission gear can be promoted the eccentric transmission linkage;
(e) An eccentric transmission linkage can be made the sliding shaft with piston route move front and rear;
(f) A fixed base for sliding shaft is functional as fixed the sliding shaft with piston route;
(g) A sliding shaft with piston route can be promoted middle-curved prop with transmission linkage;
(h) A middle-curved prop with transmission linkage can be promoted a twin-middle prop that is fixed by middle-prop fixed shaft rotated from back to front or from front to back;
(i) A middle-prop fixed shaft is fixed by the twin-middle prop;
(j) A twin-middle prop can be rotated onward to support the body of motorcycle or backward to return the original place on back area and it's end of part is a saw-toothed.

2. The device of claim 1 wherein the saw-toothed twin middle prop could be another kind of shape.
